(19) United States
(12) Patent Application Publication
(10) Pub. No.: US 2019/0226666 A1
(43) Pub. Date: Jul. 25, 2019

(54) Integrated Caps For Pole-Mounted Light Fixtures

(71) Applicant: Eaton Intelligent Power Limited, Dublin (IE)

(72) Inventors: Matthew Alan Davis, Orange, CA (US); Parth Joshi, Sugarhill, GA (US); Nam Chin Cho, Peachtree City, GA (US)

(21) Appl. No.: 16/254,278

(22) Filed: Jan. 22, 2019

Related U.S. Application Data
(60) Provisional application No. 62/621,373, filed on Jan. 24, 2018.

(51) Int. Cl. F21V 21/116; F21V 23/04; F21V 23/02; F21S 8/08; A01M 29/32

(52) U.S. Cl. CPC F21V 21/116; F21V 23/0464; A01M 29/32; F21S 8/088; F21S 8/086; F21V 23/02

(57) ABSTRACT

A light fixture can include a pole. The light fixture can also include an integrated cap disposed atop the pole, where the integrated cap includes at least one light fixture component coupling feature that couples to at least one light fixture component.

### CROSS-REFERENCE TO RELATED APPLICATIONS

This application claims priority under 35 U.S.C. § 119 to U.S. Provisional Patent Application Ser. No. 62/621,373, titled “Integrated Caps For Pole-Mounted Light Fixtures” and filed on Jan. 24, 2018, the entire contents of which are hereby incorporated herein by reference.

### TECHNICAL FIELD

The present disclosure relates generally to pole-mounted light fixtures, and more particularly to systems, methods, and devices for integrated caps for pole-mounted light fixtures.

### BACKGROUND

Outdoor light fixtures mounted on poles (e.g., street lights) have been in existence for decades. These outdoor light fixtures in many cases use old technology. Even such outdoor light fixtures that have relatively new lighting technology (e.g., light-emitting diodes (LEDs)) can lack connectivity from a communication standpoint. Replacing the entire light fixture, or even just the operable components (e.g., light sources, power supply) can be expensive.

### SUMMARY

In general, in one aspect, the disclosure relates to a light fixture that includes a pole and an integrated cap disposed atop the pole, where the integrated cap includes at least one light fixture component coupling feature that couples to at least one light fixture component.

In another aspect, the disclosure can generally relate to a bird deterrent accessory. The bird deterrent accessory can include a base and at least one coupling feature disposed in the base, where the at least one coupling feature is configured to couple to a component of a device. The bird deterrent accessory can also include at least one bird deterrent feature that extends from the base, where the at least one bird deterrent feature is configured to deter birds from resting on or near the component of the device.

In yet another aspect, the disclosure can generally relate to an integrated cap for a pole-mounted light fixture. The integrated cap can include a body having multiple walls that form a cavity. The integrated cap can include at least one light fixture component coupling feature disposed on at least one wall of the plurality of walls of the body, where the at least one light fixture component coupling feature is configured to couple to at least one light fixture component of the pole-mounted light fixture.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIGS. 1-3 show outdoor light fixtures that are currently known in the art.

FIG. 4 shows a portion of a pole-mounted light fixture with an integrated cap in accordance with certain example embodiments.

FIG. 5 shows a portion of a pole-mounted light fixture with another integrated cap in accordance with certain example embodiments.

FIG. 6 shows a bird deterrent accessory in accordance with certain example embodiments.

FIG. 7 shows an integrated cap in accordance with certain example embodiments.

FIGS. 8A and 8B show another integrated cap in accordance with certain example embodiments.

FIGS. 9A and 9B show another integrated cap in accordance with certain example embodiments.

FIGS. 10A and 10B show a portion of a pole-mounted light fixture with another integrated cap in accordance with certain example embodiments.

FIGS. 11A and 11B show a portion of a pole-mounted light fixture with yet another integrated cap in accordance with certain example embodiments.

FIG. 12 shows a portion of a pole-mounted light fixture with still another integrated cap in accordance with certain example embodiments.

FIG. 13 shows a portion of a pole-mounted light fixture with yet another integrated cap in accordance with certain example embodiments.

FIGS. 14A and 14B show a portion of a pole-mounted light fixture with the integrated cap of FIGS. 8A and 8B in accordance with certain example embodiments.

FIG. 15 shows a portion of a pole-mounted light fixture with yet another integrated cap in accordance with certain example embodiments.

FIG. 16 shows a portion of a pole-mounted light fixture with still another integrated cap in accordance with certain example embodiments.

### DETAILED DESCRIPTION

In general, example embodiments provide systems, methods, and devices for integrated caps for existing light fixtures. Example integrated caps for existing light fixtures provide a number of benefits. Such benefits can include, but are not limited to, prolonging the life and functionality of an existing light fixture, increased reliability of the light fixture, reduced power consumption, improved thermal efficiency, ease of installation, ease of maintenance, and compliance with industry standards that apply to light fixtures located in certain environments. The term “light fixture” is sometimes abbreviated as “LF” herein.

Generally speaking, example caps described herein allow for one or more functions (e.g., photocell sensing, status indication, driver function) to be located therewith and/or modularly connected thereto. In this way, example caps can allow for a more efficient design and for more efficient operation of a light fixture. The specific examples provided herein are directed to an existing light fixture where the example integrated cap can easily be installed. Alternatively, example embodiments can be part of a new light fixture.

Light fixtures with which example integrated caps can be used can be located in one or more of any of a number of environments. Examples of such environments can include, but are not limited to, indoors, outdoors, a parking lot, a parking garage, a park, a path, an open space, a street, a highway, an office space, a manufacturing plant, a warehouse, and a storage facility, both climate-controlled and non-climate-controlled. In some cases, the example embodiments discussed herein can be used in any type of hazardous environment, including but not limited to an airplane hangar, a drilling rig (as for oil, gas, or water), a production rig (as for oil or gas), a refinery, a chemical plant, a power plant, a mining operation, a wastewater treatment facility, and a steel mill.

Example integrated caps can be integrated into a pole on which a light fixture is mounted. Alternatively, example integrated caps can be used with light fixtures that are mounted on some other structure aside from a pole. In any case, example integrated caps described herein can be mounted on the housing of a light fixture or mounted remote from (but proximate to) the housing of a light fixture. A user may be any person that interacts with light fixtures and/or example integrated caps. Examples of a user may include, but are not limited to, an engineer, an electrician, an instrumentation and controls technician, a mechanic, an operator, a property manager, a homeowner, a tenant, an employee, a consultant, a contractor, and a manufacturer's representative.

Light fixtures with example integrated caps (including components thereof) can be made of one or more of a number of suitable materials to allow the light fixture to meet certain standards and/or regulations while also maintaining durability in light of the one or more conditions under which the light fixtures and/or other associated components of the light fixture can be exposed. Examples of such materials can include, but are not limited to, aluminum, stainless steel, fiberglass, glass, plastic, ceramic, and rubber.

Example integrated caps, or portions thereof, described herein can be made from a single piece (as from a mold, injection mold, die cast, or extrusion process). In addition, or in the alternative, example integrated caps can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably.

Components and/or features described herein can include elements that are described as coupling, fastening, securing, abutting against, in communication with, or other similar terms. Such terms are merely meant to distinguish various elements and/or features within a component or device and are not meant to limit the capability or function of that particular element and/or feature. For example, a feature described as a “coupling feature” can couple, secure, fasten, abut against, and/or perform other functions aside from merely coupling.

A coupling feature (including a complementary coupling feature) as described herein can allow one or more components and/or portions of an example integrated cap to become coupled, directly or indirectly, to a sensor, a pole, a housing of a light fixture, and/or some other feature of an existing light fixture. A coupling feature can include, but is not limited to, a clamp, a portion of a hinge, an aperture, a recessed area, a protrusion, a hole, a slot, a tab, a detent, and mating threads. One portion of an example integrated cap can be coupled to a sensor, a pole, a housing of a light fixture, and/or some other feature of a light fixture by the direct use of one or more coupling features.

In addition, or in the alternative, a portion of an example integrated cap can be coupled to a sensor, a pole, a housing of a light fixture, and/or some other feature of a light fixture using one or more independent devices that interact with one or more coupling features disposed on a component of the integrated cap. Examples of such devices can include, but are not limited to, a pin, a hinge, a fastening device (e.g., a bolt, a screw, a rivet), epoxy, glue, adhesive, and a spring. One coupling feature described herein can be the same as, or different than, one or more other coupling features described herein. A complementary coupling feature as described herein can be a coupling feature that mechanically couples, directly or indirectly, with another coupling feature.

In the foregoing figures showing example embodiments of integrated caps for light fixtures, one or more of the components shown may be omitted, repeated, and/or substituted. Accordingly, example embodiments of integrated caps for light fixtures should not be considered limited to the specific arrangements of components shown in any of the figures. For example, features shown in one or more figures or described with respect to one embodiment can be applied to another embodiment associated with a different figure or description.

In certain example embodiments, light fixtures having example integrated caps are subject to meeting certain standards and/or requirements. For example, the National Electric Code (NEC), the National Electrical Manufacturers Association (NEMA), the International Electrotechnical Commission (IEC), the Federal Communication Commission (FCC), Underwriters Laboratories (UL), and the Institute of Electrical and Electronics Engineers (IEEE) set standards as to electrical enclosures, wiring, and electrical connections. Use of example embodiments described herein meet (and/or allow the retrofitted light fixture to meet) such standards when applicable.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit or four-digit number, and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of integrated caps for light fixtures will be described more fully hereinafter with reference to the accompanying drawings, in which example embodiments of integrated caps for light fixtures are shown. Integrated caps for light fixtures may, however, be embodied in many different forms and should not be construed as limited to the example embodiments set forth herein. Rather, these example embodiments are provided so that this disclosure will be thorough and complete, and will fully convey the scope of integrated caps for light fixtures to those of ordinary skill in the art. Like, but not necessarily the same, elements (also sometimes called components) in the various figures are denoted by like reference numerals for consistency.

Terms such as “first”, “second”, “above”, “below”, “inner”, “outer”, “distal”, “proximal”, “end”, “top”, “bottom”, “side”, and “within” are used merely to distinguish one component (or part of a component or state of a component) from another. Such terms are not meant to denote a preference or a particular orientation, and are not meant to limit embodiments of integrated caps for light fixtures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

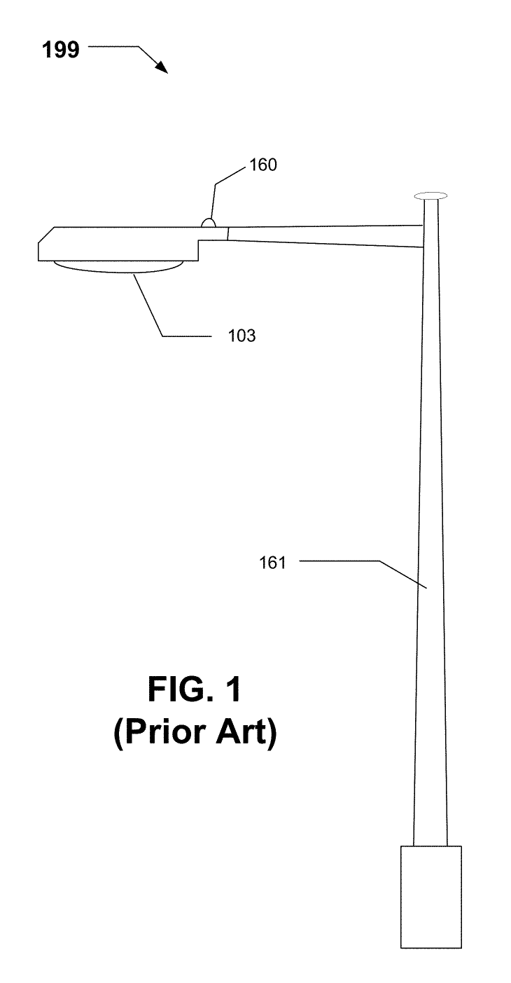

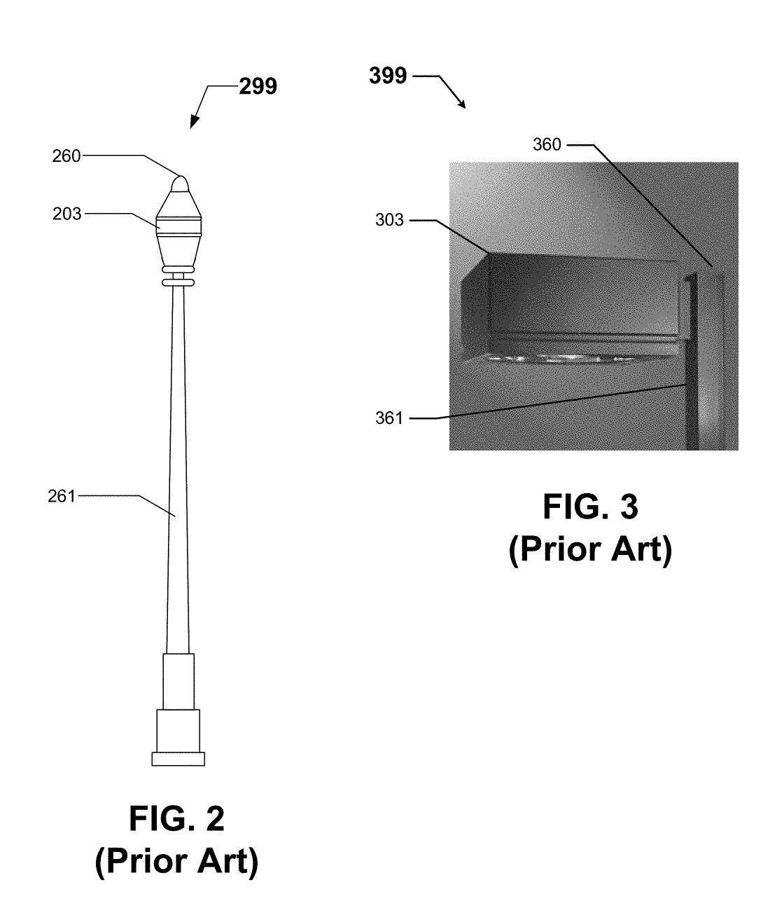

FIGS. 1-3 show various light fixtures currently used in the art. Specifically, FIG. 1 shows a light fixture 199 in the form of a street light. FIG. 2 shows a light fixture 299 used in a park or walkway. FIG. 3 shows a light fixture 399 used in a parking lot. The light fixture 199 of FIG. 1 includes a light fixture housing 103 that is mounted on a pole 161. The light fixture housing 103 has a sensor device 160 (e.g., a photocell) disposed thereon. The location of the sensor device 160 (also more simply called a sensor 160 herein) atop the housing 103 can be unsightly and limits the design flexibility of the housing 103 and the street light 199 in general.

The light fixture 299 of FIG. 2 includes a light fixture housing 203 that is mounted on top of a pole 261. The light fixture housing 203 has a sensor device 260 (e.g., a photocell) disposed atop thereof. The light fixture 399 of FIG. 3 includes a light fixture housing 303 that is mounted on a pole 361. There is a sensor device 360 (e.g., a photocell) disposed atop the pole 361, proximate to but not directly coupled to the light fixture housing 303.

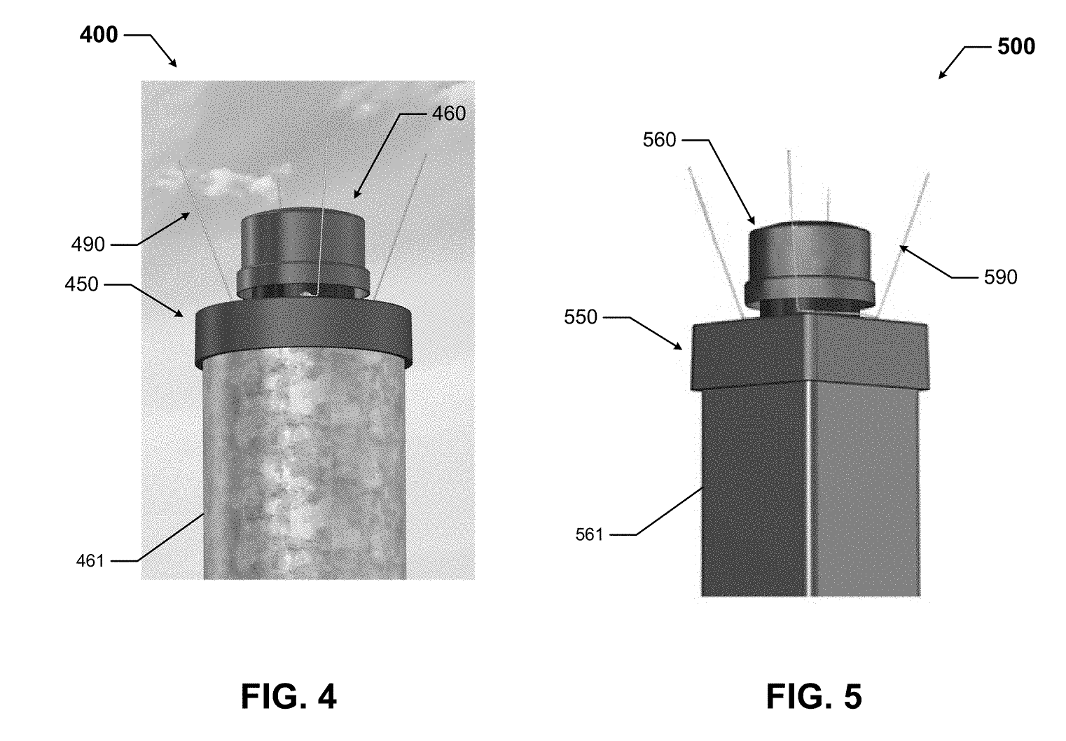

FIG. 4 shows a portion of a pole-mounted light fixture 400 with an integrated cap 450 in accordance with certain example embodiments. Referring to FIGS. 1-4, the portion of a pole-mounted light fixture 400 of FIG. 4 shows the example integrated cap 450 disposed atop a pole 461. The pole 461, when viewed from above, is circular in shape. Similarly, the cap 450 is circular when viewed from above, where the diameter of the inner surface of the cap 450 is slightly larger than the diameter of the outer surface of the pole 461. More details about the example cap are provided below with respect to FIGS. 7-9B.

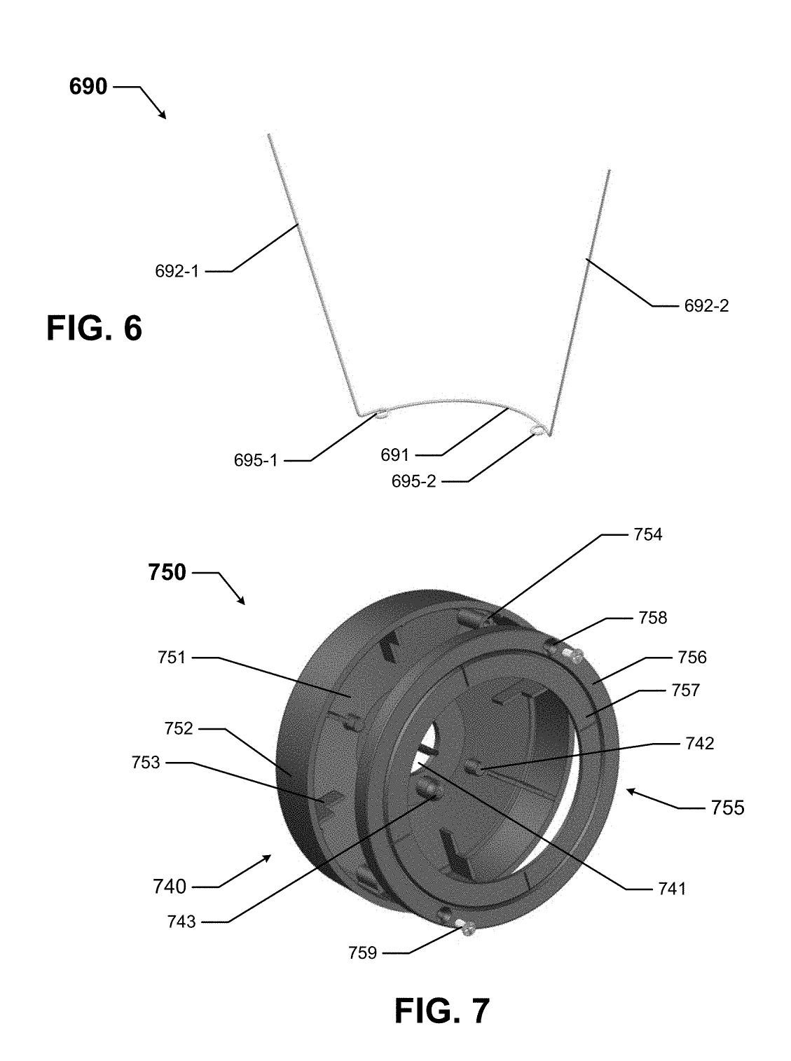

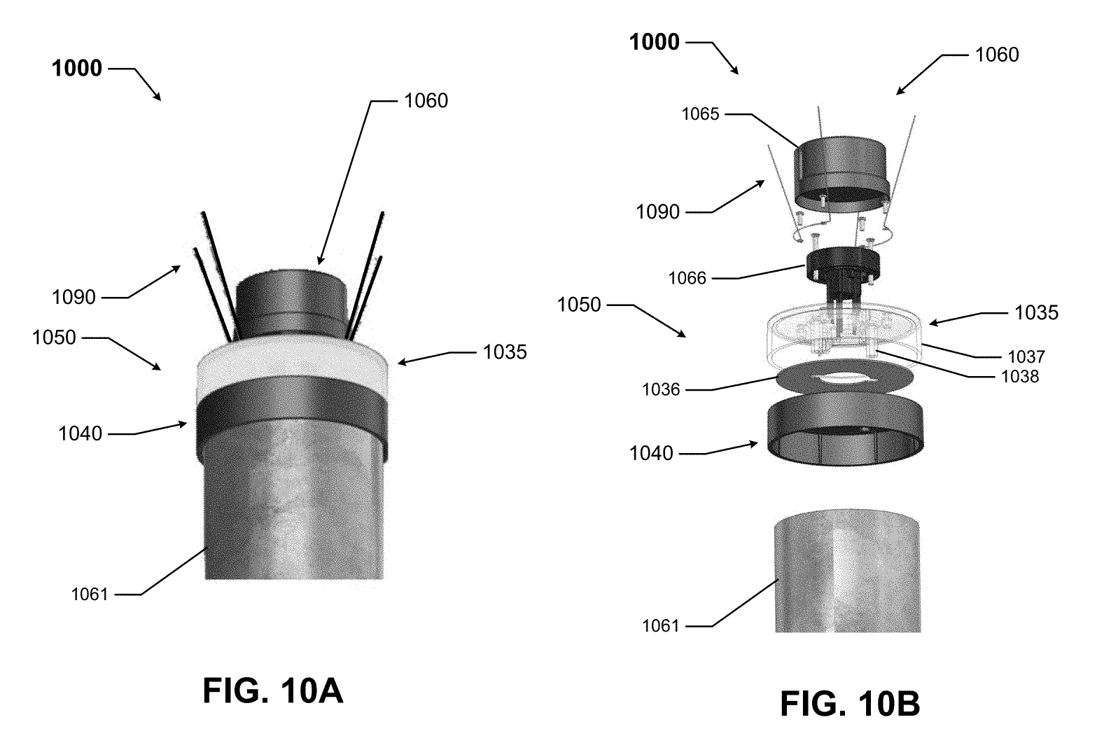

Coupled to the top of the cap 450 is a sensor 460 (e.g., a photocontrol receptacle (PCR)). When the sensor 460 is a PCR, as in this case, the sensor measures an amount of ambient light. In addition to, or instead of, ambient light, a sensor 460 can measure and/or detect any of a number of other parameters, including but not limited to movement and temperature. More details about the sensor 460 are provided below with respect to FIGS. 10A and 10B. Also disposed atop the cap 450 is a bird deterrent accessory 490, details of which are provided below with respect to FIG. 6.

FIG. 5 shows a portion of a pole-mounted light fixture 500 with another integrated cap 550 in accordance with certain example embodiments. Referring to FIGS. 1-5, the portion of a pole-mounted light fixture 500 of FIG. 5 shows the example integrated cap 550 disposed atop a pole 561. The pole 561, when viewed from above, is square in shape. Similarly, the cap 550 is square when viewed from above, where the size (e.g., perimeter) of the inner surface of the cap 550 is slightly larger than the size formed by the outer perimeter of the pole 561. At stated above, more details about the example cap are provided below with respect to FIGS. 7-9B. Coupled to the top of the cap 550 is a sensor 560 and a bird deterrent accessory 590, both of which are discussed in more detail below.

FIG. 6 shows a bird deterrent accessory 690 in accordance with certain example embodiments. Referring to FIGS. 1-6, the bird deterrent accessory 690 is designed to couple to an example cap (e.g., cap 450), or even some other component (e.g., a housing) of a light fixture, in order to deter birds or other animals from sitting on the cap or other component. By deterring birds and other animals in this way, the cap or other component can avoid damage (as from punctures from a claw, cracking from excessive weight, deterioration from excrement) and/or malfunction that can result from the bird or other animal being disposed atop the cap or other component.

An example bird deterrent accessory 690, or portions thereof, described herein can be made from a single piece (as from a mold, a wire, or extrusion process). In addition, or in the alternative, example bird deterrent accessories 690 can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, snap fittings, and slotted fittings. One or more pieces that are mechanically coupled to each other can be coupled to each other in one or more of a number of ways, including but not limited to fixedly, hingedly, removeably, slidably, and threadably. In this case, the bird deterrent accessory 690 is a single elongated wire.

The bird deterrent accessory 690 can include one or more of a number of features. For example, as shown in FIG. 6, the bird deterrent accessory 690 can include a base 691, at least one coupling feature 695, and at least one bird deterrent feature 692. In this case, each such feature is represented by a bend or other manipulation of the single elongated wire that is the bird deterrent accessory 690. The base 691 is configured to provide support for the one or more other features of the bird deterrent accessory 690. The base 691 can have a shape and/or size to abut against the example cap (e.g., cap 550). For example, the base 691 of the bird deterrent accessory 690 can abut against the outer surface of the top wall (e.g., top wall 751 in FIG. 7 below) of the cap.

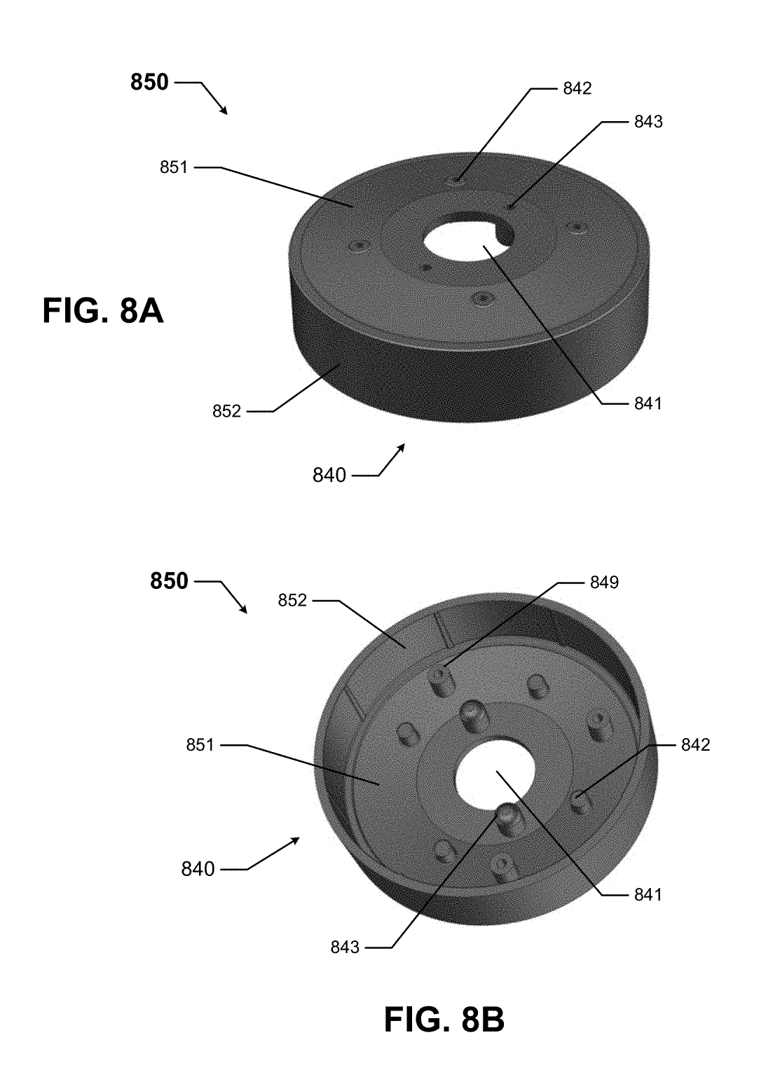

The one or more coupling features 695 are configured to couple, directly or indirectly, the bird deterrent accessory 690 to the example cap or other component of a light fixture. The coupling features 695 of FIG. 6 are integrated with the base 691, but can be disposed at other locations of the bird deterrent accessory 690. In this case, there are two coupling features 695 (coupling feature 695-1 and coupling feature 695-2) that are identical to each other and are in the form of holes through which a fastening device (e.g., a bolt, a rivet, a screw) can be disposed. The coupling features 695 are configured to align with complementary coupling features (e.g., coupling features 842 of FIG. 8 below) in the cap or other component of a light fixture.

The one or more bird deterrent features 692 are configured to physically deter birds and other animals from settling on or near the bird deterrent accessory 690. The bird deterrent features 692-1 and 692-2 of FIG. 6 extend from the base 691, but can be disposed at other locations of the bird deterrent accessory 690. In this case, there are two bird deterrent features 692 that are identical to each other and are in the form of linear segments that extend upward and away from the base 691.

In this case, the bird deterrent accessory 690 is configured to cover approximately ¼ of the outer perimeter of a circular object (e.g., the sensor 590 of FIG. 5). In this way, two bird deterrent accessories 690 can be combined to cover an entire outer perimeter of the circular (or other shaped) object. Alternatively, the bird deterrent accessory 690 can be a single piece that covers an entire outer perimeter of the circular (or other shaped) object.

FIG. 7 shows a bottom-side perspective view of an integrated cap 750 in accordance with certain example embodiments. Referring to FIGS. 1-7, the integrated cap 750 can include one or more portions. For example, as shown in FIG. 7, the example integrated cap 750 can include a base 740 and an adapter 755. The base 740 in this case is cylindrical in shape with a side wall 752 and a top wall 751. The bottom of the base 740 is open. The top wall 751 has an aperture 741 that traverses therethrough. In this case, the aperture 741 is circular and is centered on the top wall 751. In some cases, the top wall 751 can be domed to allow for water and dirt to run off its sides.

The top wall 751 can also include one or more coupling features. For example, the top wall 751 of FIG. 7 includes a number (in this case, two) of coupling features 743 (in this cases, bosses with threaded apertures (viewable from above)) that are configured to receive one or more complementary coupling features of a sensor (e.g., sensor 460) or other component of the light fixture that can be disposed atop the cap 750. In addition, the top wall 751 of FIG. 7 includes a number (in this case, four) of coupling features 742 (in this cases, bosses with threaded apertures (viewable from above)) that are configured to receive one or more complementary coupling features (e.g., coupling features 695) of one or more bird deterrent accessories (e.g., bird deterrent accessory 690) that can be disposed atop the cap 750. Coupling features 742 and coupling features 743 can generally be called light fixture component coupling features herein, as each of these coupling features are configured to couple to another component (e.g., a sensor, a bird deterrent accessory, a mounting bracket) of the associated light fixture.

Further, the top wall 751 of FIG. 7 includes a number (in this case, two) of coupling features 754 (in this cases, bosses with threaded apertures) that are configured to align with one or more complementary coupling features (e.g., coupling features 758) and to receive one or more other complementary coupling features (e.g., coupling features 759) of the adapter 755 of the cap 750. The base 740 can also include one or more alignment features 753 disposed on the inner surface of the top wall 751 and/or the inner surface of the side wall 752 to help align a pole (e.g., pole 461) with respect to the cap 750.

The adapter 755 of the example cap 750 is an optional feature that, when present, is coupled to the base 740. Specifically, the adapter 755 can include one or more (in this case, two) coupling features 758 that couple, directly or indirectly, with complementary coupling features 754 of the base 740. In this example, the coupling features 758 are apertures that traverse the thickness of the adapter 755 and align with the coupling features 754 of the base 740. Coupling features 759 (in this case, threaded screws) are disposed within coupling features 754 and coupling features 758 to couple the adapter 755 to the base 740.

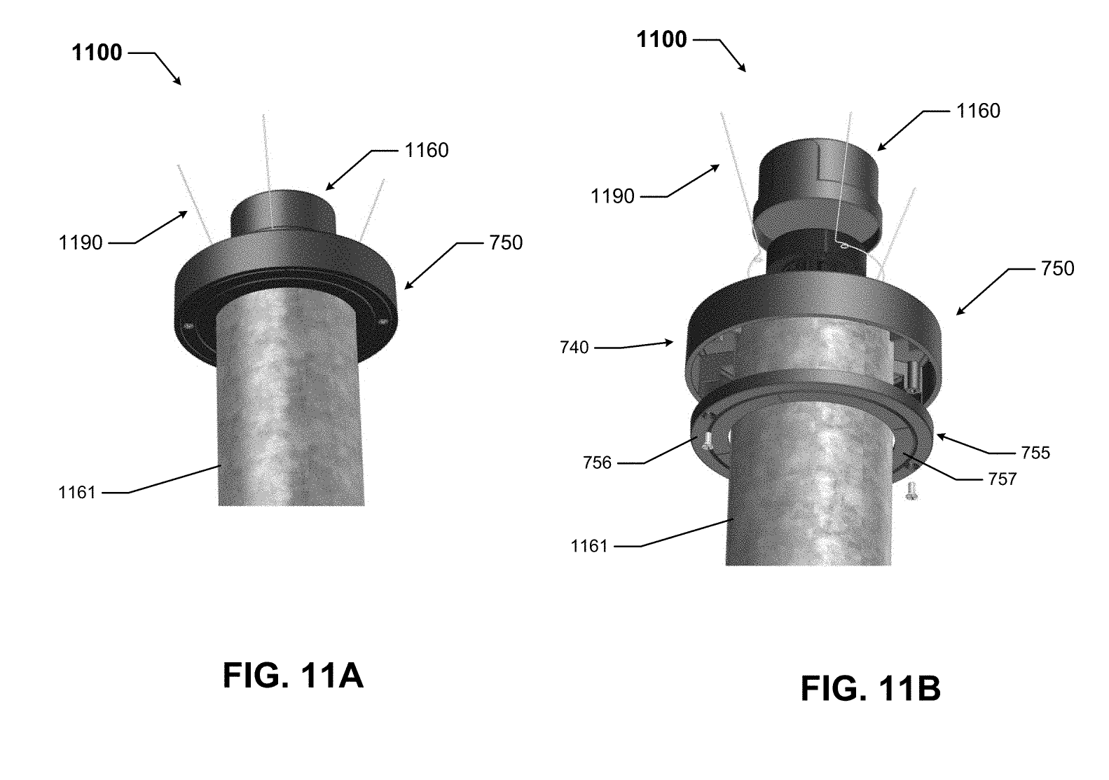

The adapter 755 is designed to allow a larger-sized base 740 to be used with a smaller-sized pole by filling the space therebetween and providing a seal against the pole. FIGS. 11A and 11B show an example of cap 750 used with a pole. The adapter 755 can have multiple features (in this case, feature 757 and feature 756) that are concentric with each other, where an inner feature (in this case, feature 757) can be removed, leaving an outer feature (in this case, feature 756) in place to allow for a larger-sized pole. The shape of each such feature can match the cross-sectional shape of the pole. Examples of such shapes can include, but are not limited to, a circle (as in this example), a square, a rectangle, and an oval.

Alternatively, rather than removable features, the adapter 755 can be expandable and/or retractable to conform to the shape and size of a pole disposed therein. In any case, the adapter 755 can include one or more sealing members (e.g., gaskets, O-rings, silicone) that can be used to provide a seal between the adapter 755 and the pole. Similarly, the adapter 755 and/or the base 740 can include one or more sealing members (e.g., gaskets, O-rings, silicone) that can be used to provide a seal between the adapter 755 and the base 740. Such sealing members can be used to prevent or reduce the amount of moisture, dirt, and other elements from the ambient environment from entering inside the pole.

An example cap (e.g., cap 750) described herein can also include one or more of a number of coupling features that secure the cap to a pole. For example, there can be one or more threaded apertures (a form of coupling feature) that traverses a side wall (e.g., side wall 752) of the cap. In such a case, one or more fastening devices (e.g., set screws) can be disposed therein and driven into the outer surface of the pole, creating a friction fit between the cap and the pole. Other examples of using coupling features to secure the cap against the pole will be obvious to those of ordinary skill in the art.

FIGS. 8A and 8B show another integrated cap 850 in accordance with certain example embodiments. Specifically, FIG. 8A shows a top-side perspective view of the cap 850, and FIG. 8B shows a bottom-side perspective view of the cap 850. Referring to FIGS. 1-8B, the cap 850 of FIGS. 8A and 8B is substantially similar to the cap 750 of FIG. 7, except as described below. In this case, the cap 850 of FIGS. 8A and 8B only includes a base 840 and no adapter. This means that no adapter is needed because the cross-sectional shape (in this case, circular) of the base 840 is the same as the cross-sectional shape of the pole, and the size of the base 840 is slightly larger than the size of the pole.

The base 840 of the cap 850 of FIGS. 8A and 8B also does not have any alignment features, as was the case with the cap 750 of FIG. 7. Again, since the cross-sectional shape and size of the base 840 in this case is sufficient for a snug fit on the pole without an adapter, no additional alignment of the pole relative to the base 840 is needed. The base 840 of the cap 850 of FIGS. 8A and 8B includes a top wall 851 and a side wall 852. The top wall 851 has an aperture 841 that traverses therethrough. In this case, the aperture 841 is circular and is centered on the top wall 851. In some cases, the top wall 851 can be domed to allow for water and dirt to run off its sides.

As with the cap 750 of FIG. 7, the top wall 851 of the base 840 includes one or more coupling features. For example, the top wall 851 of FIGS. 8A and 8B includes a number (in this case, two) of coupling features 843 (in this case, bosses with threaded apertures) that are configured to receive one or more complementary coupling features of a sensor (e.g., sensor 460) or other component of the light fixture that can be disposed atop the cap 850. In addition, the top wall 851 of FIGS. 8A and 8B includes a number (in this case, four) of coupling features 842 (in this cases, bosses with threaded apertures) that are configured to receive one or more complementary coupling features (e.g., coupling features 695) of one or more bird deterrent accessories (e.g., bird deterrent accessory 690) that can be disposed atop the cap 850.

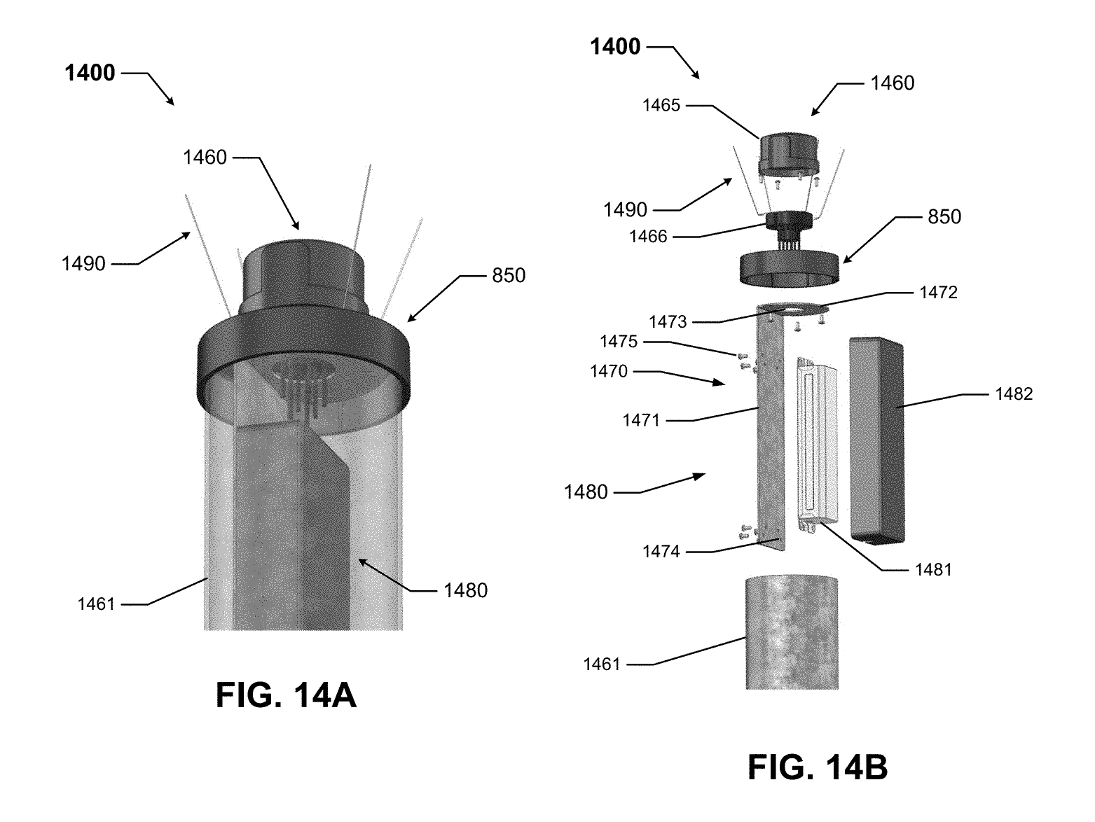

In addition, the top wall 851 of FIGS. 8A and 8B includes a number (in this case, three) of coupling features 849 (in this cases, bosses with threaded apertures) that are configured to receive one or more complementary coupling features (e.g., coupling features 695) of a component (e.g., mounting bracket 1470 of FIG. 14B below) that can be disposed within the pole covered by the cap 850. Coupling features 842, coupling features 843, and coupling features 849 can generally be called light fixture component coupling features herein, as each of these coupling features are configured to couple to another component (e.g., a sensor, a bird deterrent accessory, a mounting bracket) of the associated light fixture.

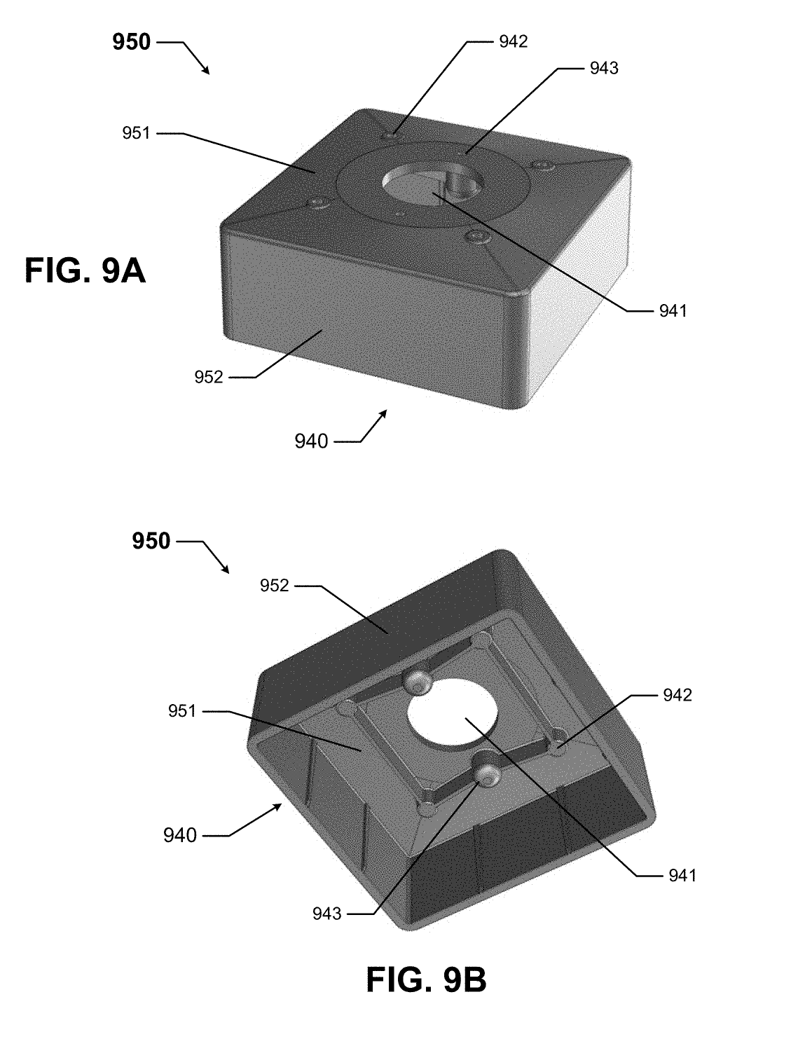

FIGS. 9A and 9B show another integrated cap 950 in accordance with certain example embodiments. Specifically, FIG. 9A shows a top-side perspective view of the cap 950, and FIG. 9B shows a bottom-side perspective view of the cap 950. Referring to FIGS. 1-9B, the cap 950 of FIGS. 9A and 9B is substantially similar to the cap 750 of FIG. 7 and the cap 850 of FIGS. 8A and 8B, except as described below. In this case, the cap 950 of FIGS. 9A and 9B only includes a base 940 and no adapter. This means that no adapter is needed because the cross-sectional shape (in this case, square) of the base 940 is the same as the cross-sectional shape of the pole, and the size of the base 940 is slightly larger than the size of the pole.

The base 940 of the cap 950 of FIGS. 9A and 9B also does not have any alignment features, as was the case with the cap 750 of FIG. 7. Again, since the cross-sectional shape and size of the base 940 in this case is sufficient for a snug fit on the pole without an adapter, no additional alignment of the pole relative to the base 940 is needed. The base 940 of the cap 950 of FIGS. 9A and 9B includes a top wall 951 and a side wall 952. The top wall 951 has an aperture 941 that traverses therethrough. In this case, the aperture 941 is circular and is centered on the top wall 951. In some cases, the top wall 951 can be domed to allow for water and dirt to run off its sides.

As with the cap 750 of FIG. 7 and the cap 850 of FIGS. 8A and 8B, the top wall 951 of the base 940 includes one or more coupling features. For example, the top wall 951 of FIGS. 9A and 9B includes a number (in this case, two) of coupling features 943 (in this case, bosses with threaded apertures) that are configured to receive one or more complementary coupling features of a sensor (e.g., sensor 460) or other component of the light fixture that can be disposed atop the cap 950. In addition, the top wall 951 of FIGS. 9A and 9B includes a number (in this case, four) of coupling features 942 (in this cases, bosses with threaded apertures) that are configured to receive one or more complementary coupling features (e.g., coupling features 695) of one or more bird deterrent accessories (e.g., bird deterrent accessory 690) that can be disposed atop the cap 950.

Unlike the integrated cap 850 of FIGS. 8A and 8B, the cap 950 of FIGS. 9A and 9B do not have coupling features (e.g., coupling features 849) that are configured to couple to a mounting bracket. Coupling features 942 and coupling features 943 can generally be called light fixture component coupling features herein, as each of these coupling features are configured to couple to another component (e.g., a sensor, a bird deterrent accessory, a mounting bracket) of the associated light fixture.

FIGS. 10A and 10B show a portion of a pole-mounted light fixture 1000 with another integrated cap 1050 in accordance with certain example embodiments. Specifically, FIG. 10A shows a bottom-side view of the light fixture 1000, and FIG. 10B shows an exploded side view of the light fixture 1000. Referring to FIGS. 1-10B, the cap 1050 of FIGS. 10A and 10B includes a body 1040, no adapter, and a stacking cap 1035. The body 1040 of the cap 1050 of FIGS. 10A and 10B is disposed atop the pole 1061 and can be substantially the same as the caps described above with respect to FIGS. 7-9B.

The stacking cap 1035 is a feature of the integrated cap 1050 that has not previously been discussed herein. The stacking cap 1035 can have one or more of a number of features that are substantially the same as features of the base 1040. For example, the stacking cap 1035 can have at least one side wall 1037, a top wall (hidden from view in FIGS. 10A and 10B), an aperture that traverses the top wall (also hidden from view in FIGS. 10A and 10B), and one or more of a number of coupling features (e.g., coupling features 1038). In such a case, the stacking cap 1035 can be coupled to the base 1040 and act as a vertical extension of the integrated cap 1050.

Since the stacking cap 1035 can include some of the same features as the base 1040 of the integrated cap 1050, the sensor device 1060 and the bird deterrent accessory 1090 can be coupled to the top wall of the stacking cap 1035 in much the same was that those components (e.g., sensor device 460 and bird deterrent accessory 490) can be coupled to the top wall of the base, as shown in FIGS. 4 and 5 above.

The stacking cap 1035 can be used to house one or more components of and/or used for the light fixture 1000. For example, in this case, the stacking cap 1035 can have disposed therein a circuit board 1036. The circuit board 1036 can include any of a number of electrical components (e.g., capacitors, resistors, transistors, diodes, power modules, integrated circuits, hardware processors, memory, sensor devices, light sources). For example, the circuit board 1036 can include a light source that illuminates one color (e.g., green) when the light fixture 1000 is functioning properly, another color (e.g., blue) when the light fixture 1000 (or component thereof) is functioning improperly, and yet another color (e.g., red) when there is an emergency in the area. In such a case, the side wall 1037 of the stacking cap 1035 can be clear to allow the light emitted by the light source to show into the ambient environment.

A sensor device (e.g., sensor device 1060) of a light fixture (e.g., light fixture 1000) can include one or more components. For example, as shown in FIGS. 10A and 10B, the sensor device 1060 can include a housing 1065 and a sensing component 1066 disposed within the housing 1065. The sensing component 1066 can have one or more of a number of leads (e.g., electrical wires) that extend downward through the aperture in the top wall of the stacking cap 1035, through an aperture in the circuit board 1036, and through the aperture in the top wall of the base 1040 so that those leads can couple to a component disposed within the pole 1061.

FIGS. 11A and 11B show a portion of a pole-mounted light fixture 1100 with yet another integrated cap in accordance with certain example embodiments. Specifically, FIG. 11A shows a bottom-side view of the light fixture 1100, and FIG. 11B shows an exploded side view of the light fixture 1100. Referring to FIGS. 1-11B, the pole 1161 is cylindrically shaped and has an outer diameter of 4 inches. The integrated cap 750 of FIG. 7 is disposed atop the pole 1161, and the inner diameter of the side wall of the body 740 is approximately six inches. As a result, the adapter 755 is used. Because of the difference between the outer diameter of the pole 1161 and the inner diameter of the body 740 of the integrated cap 750, the adapter 755 includes both feature 757 and feature 756. A sensor device 1160 and a bird deterrent accessory 1190, substantially similar to the sensor devices and bird deterrent accessories discussed above, are coupled to the top of the body 740 of the integrated cap 750 in a manner substantially similar to what is described above.

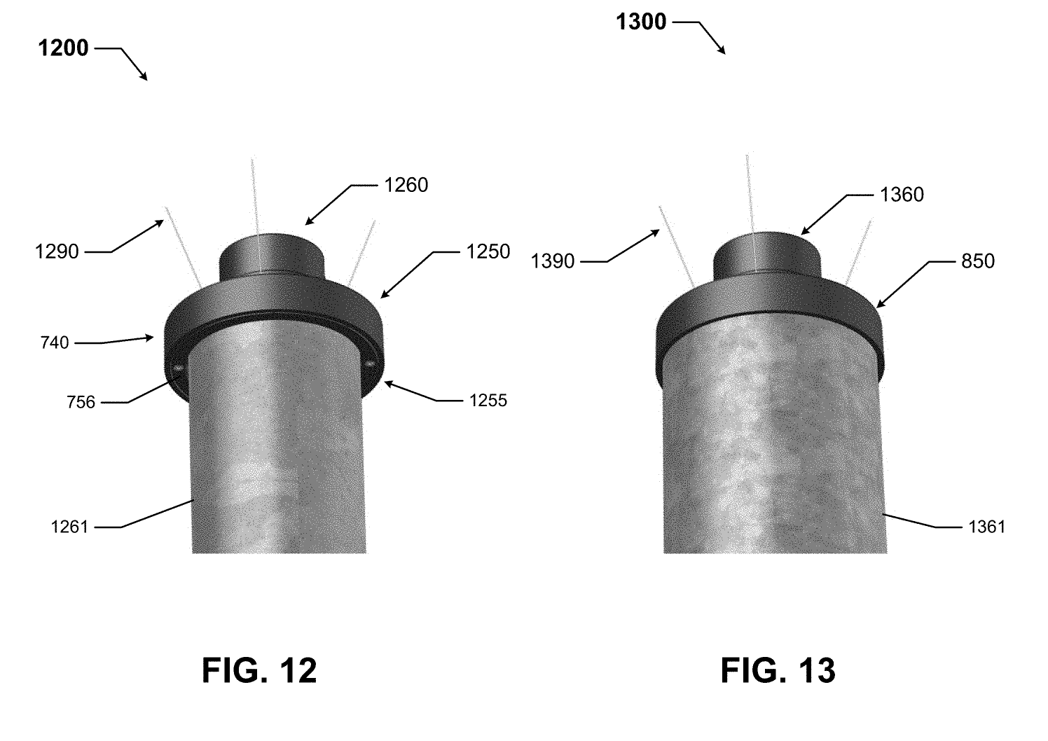

FIG. 12 shows a portion of a pole-mounted light fixture 1200 with still another integrated cap in accordance with certain example embodiments. Referring to FIGS. 1-12, the pole 1261 is cylindrically shaped and has an outer diameter of 5 inches. The integrated cap 1250 is disposed atop the pole 1261. The integrated cap 1250 of FIG. 12 includes the body 740 of the integrated cap 740 of FIG. 7, as well as an adapter 1255 that is a reduced version of the adapter 755 of FIG. 7. The inner diameter of the side wall of the body 740 is approximately six inches. As a result, the adapter 1255 is used. Because of the difference between the outer diameter of the pole 1261 and the inner diameter of the body 740 of the integrated cap 1250, the adapter 1255 only includes feature 756 (and not feature 757) from the adapter 755 of FIG. 7. A sensor device 1260 and a bird deterrent accessory 1290, substantially similar to the sensor devices and bird deterrent accessories discussed above, are coupled to the top of the body 740 of the integrated cap 1250 in a manner substantially similar to what is described above.

FIG. 13 shows a portion of a pole-mounted light fixture with yet another integrated cap in accordance with certain example embodiments. Referring to FIGS. 1-13, the pole 1361 is cylindrically shaped and has an outer diameter of 6 inches. The integrated cap 850 is disposed atop the pole 1361. The integrated cap 850 of FIG. 13 is the same as the integrated cap 850 of FIGS. 8A and 8B above. The inner diameter of the side wall of the body of the cap 850 is approximately six inches. As a result, no adapter is included in the integrated cap 850. A sensor device 1360 and a bird deterrent accessory 1390, substantially similar to the sensor devices and bird deterrent accessories discussed above, are coupled to the top of the body of the integrated cap 850 in a manner substantially similar to what is described above.

FIGS. 14A and 14B show a portion of a pole-mounted light fixture 1400 with the integrated cap 850 of FIGS. 8A and 8B in accordance with certain example embodiments. Specifically, FIG. 14A shows a semi-transparent bottom-side view of the light fixture 1400, and FIG. 14B shows an exploded side view of the light fixture 1400. Referring to FIGS. 1-14B, the pole 1461 is cylindrically shaped and has an outer diameter of 6 inches. The integrated cap 850 is disposed atop the pole 1461. The integrated cap 850 of FIG. 14 is the same as the integrated cap 850 of FIGS. 8A and 8B above. The inner diameter of the side wall of the body of the cap 850 is approximately six inches. As a result, no adapter is included in the integrated cap 850. A sensor device 1460 and a bird deterrent accessory 1490, substantially similar to the sensor devices and bird deterrent accessories discussed above, are coupled to the top of the body of the integrated cap 850 in a manner substantially similar to what is described above.

In addition, the light fixture 1400 includes a power source assembly 1480 disposed within the pole 1461 and coupled to the integrated cap 850. The power source assembly 1480 can include one or more of a number of components. For example, in this case, the power source assembly 1480 can include a mounting bracket 1470, a power source 1481 (e.g., a LED driver), and a cover 1482. The cover 1482 covers some or all of the power source 1481, which is coupled to a body 1471 of the mounting bracket 1470.

Extending perpendicularly from the top end of the body 1471 of the mounting bracket 1470 is an extension 1472 that includes one or more of a number of coupling features (in this case, apertures that traverse the thickness of the extension 1472) for coupling the mounting bracket 1470 to another component (in this case, the coupling features 849 of the integrated cap 850) of the light fixture 1400. The extension 1472 can have, as in this example, an aperture 1473 that traverses therethrough. The aperture 1473 in this case is disposed in the center of the extension 1472, but in other cases, the aperture 1473 can be disposed at any location of the extension 1472. The aperture 1473 can have any shape (e.g., circular, square, octagonal) or size.

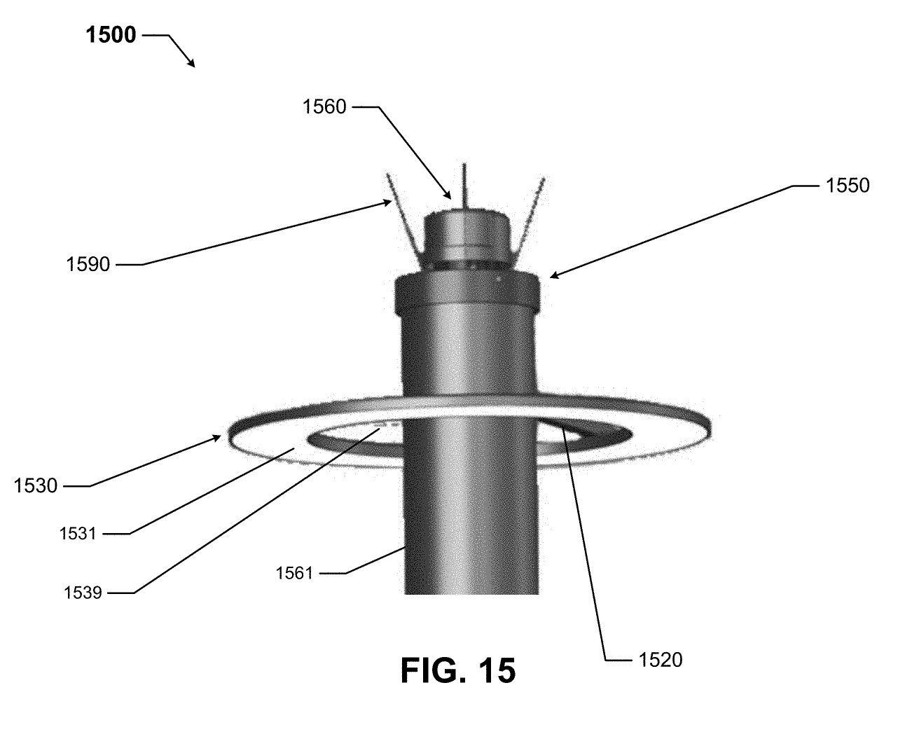

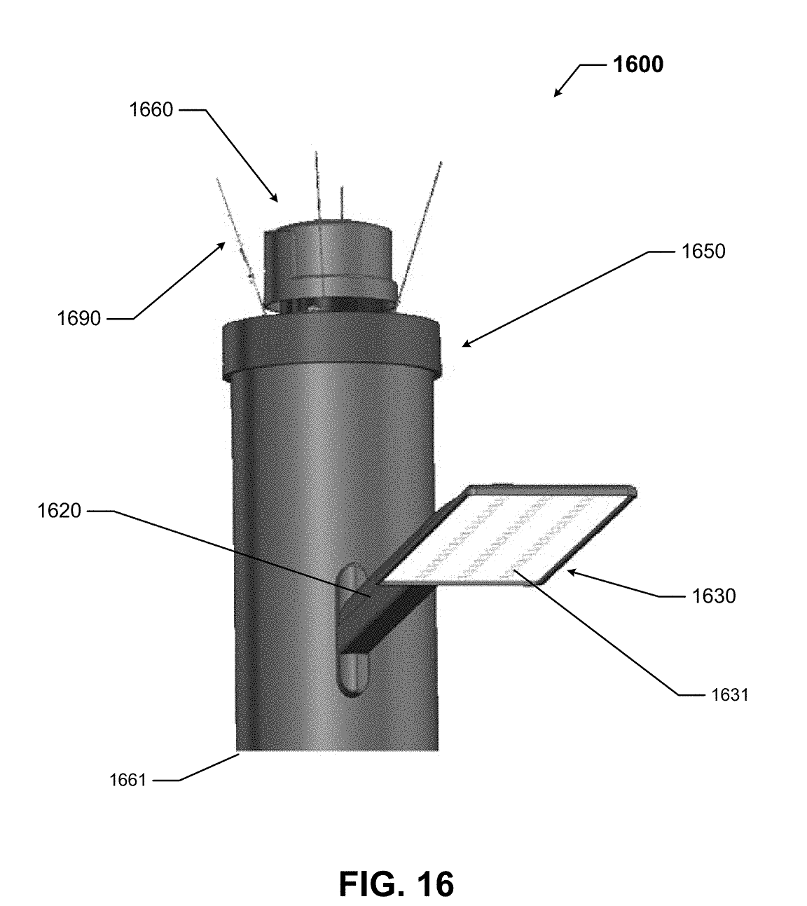

By placing the power source 1481 in the cavity formed by the wall of the pole 1461, it can be removed from being disposed on or within a light fixture housing, where it is located in the current art. When the wall of the pole 1461 is made of a thermally conductive material (e.g., metal), the wall of the pole 1461 can act as a heat sink. In other words, the heat generated by the power source 1481 during operation can be absorbed by the pole 1461 and dissipated into the ambient environment. Because of the significantly larger size (e.g., surface area) of the pole 1461 relative to a light fixture housing, the arrangement shown in FIGS. 14A and 14B results in significantly higher thermal efficiency. This, in turn, leads to a longer expected useful life of the light fixture 1400 and its components, as well as increased design flexibility of the light fixture housing, as shown below with respect to FIGS. 15 and 16.

FIG. 15 shows a portion of a pole-mounted light fixture 1500 with yet another integrated cap 1550 in accordance with certain example embodiments. Referring to FIGS. 1-15, the pole 1561 is cylindrically shaped. The integrated cap 1550 is disposed atop the pole 1561. The integrated cap 1550 is also circular (when viewed from above), and the inner diameter (e.g., approximately 5 inches) of the side wall of the body of the cap 1550 is slightly larger than the outer diameter of the wall of the pole 1561. As a result, no adapter is included in the integrated cap 1550. A sensor device 1560 and a bird deterrent accessory 1590, substantially similar to the sensor devices and bird deterrent accessories discussed above, are coupled to the top of the body of the integrated cap 1550 in a manner substantially similar to what is described above.

Also shown in FIG. 15 is a light fixture housing 1530. In this case, the light fixture housing 1530 is a ring that is concentrically positioned around the pole 1561. The light fixture housing 1530 is held in place by a mounting feature 1520 that extends from the outer surface of the wall of the pole 1561 to the light fixture housing 1530. There is a gap 1539 between the light fixture housing 1530 and the pole 1561 that is substantially uniform around the outer perimeter of the pole 1561.

The light fixture housing 1530 has an extremely low profile relative to light fixture housings of pole-mounted light fixtures currently known in the art. The reason for this is because, aside from one or more light sources 1531, many of the components currently located in or on light fixture housings in the current art are not present with the light fixture housing 1530 of FIG. 15. For example, the sensor 1560 is mounted atop the integrated cap 1550 rather than on the light fixture housing 1530. As another example, the power source (e.g., LED driver) (hidden from view in FIG. 15), usually located in or on a light fixture housing of a pole-mounted light fixture in the current art, is now located inside the pole 1561 and held in place by the integrated cap 1550 using example embodiments.

FIG. 16 shows a portion of a pole-mounted light fixture 1600 with still another integrated cap 1650 in accordance with certain example embodiments. Referring to FIGS. 1-16, the pole 1661 is cylindrically shaped. The integrated cap 1650 is disposed atop the pole 1661. The integrated cap 1650 is also circular (when viewed from above), and the inner diameter (e.g., approximately 4 inches) of the side wall of the body of the cap 1650 is slightly larger than the outer diameter of the wall of the pole 1661. As a result, no adapter is included in the integrated cap 1650. A sensor device 1660 and a bird deterrent accessory 1690, substantially similar to the sensor devices and bird deterrent accessories discussed above, are coupled to the top of the body of the integrated cap 1650 in a manner substantially similar to what is described above.

Also shown in FIG. 16 is a light fixture housing 1630. In this case, the light fixture housing 1630 is rectangular-shaped and extends at an angle from the pole 1661. The light fixture housing 1630 is held in place by a mounting feature 1620 that extends from the outer surface of the wall of the pole 1661 to the light fixture housing 1630. Like the light fixture housing 1530 of FIG. 15, the light fixture housing 1630 of FIG. 16 has an extremely low profile relative to light fixture housings of pole-mounted light fixtures currently known in the art. Again, the reason for this is because, aside from the multiple light sources 1631, many of the components currently located in or on light fixture housings in the current art are not present with the light fixture housing 1630 of FIG. 16. For example, the sensor 1660 is mounted atop the integrated cap 1650 rather than on the light fixture housing 1630. As another example, the power source (e.g., LED driver) (hidden from view in FIG. 16), usually located in or on a light fixture housing of a pole-mounted light fixture in the current art, is now located inside the pole 1661 and held in place by the integrated cap 1650 using example embodiments.

Example embodiments of integrated caps described herein allow a pole-mounted light fixture to become more aesthetically pleasing by more seamlessly integrating one or more sensors. Example embodiments can also allow for the reconfiguration of one or more components (e.g., a power source) of a pole-mounted light fixture by integrating such components, currently disposed in or on a light fixture housing, into the example integrated cap and/or into the pole, supported by the integrated cap. Example embodiments can also deter birds and other animals from resting on various specific location of a pole-mounted light fixture. Example integrated caps can also prolong the life and functionality of a pole-mounted light fixture, increase the reliability of the light fixture, reduce overall power consumption, have an ease of installation, have an ease of maintenance, and comply with industry standards that apply to light fixtures located in certain environments.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A light fixture, comprising:
a pole; and
an integrated cap disposed atop the pole, wherein the integrated cap comprises at least one light fixture component coupling feature that couples to at least one light fixture component.

2. The light fixture of claim 1, wherein the at least one light fixture component comprises a sensor device, wherein the sensor device is disposed atop the integrated cap.

3. The light fixture of claim 2, wherein the sensor device detects an amount of ambient light.

4. The light fixture of claim 1, wherein the at least one light fixture component comprises at least one bird deterrent accessory, wherein the at least one bird deterrent accessory is disposed atop the integrated cap.

5. The light fixture of claim 1, wherein the at least one light fixture component comprises a power source assembly, wherein the power source assembly is disposed inside the pole.

6. The light fixture of claim 5, wherein the power source assembly comprises a mounting bracket and a power source, wherein the mounting bracket is coupled to the power source inside the pole, and wherein the mounting bracket is further coupled to the integrated cap.

7. The light fixture of claim 1, wherein the power source provides power and control to at least one light source of the light fixture.

8. The light fixture of claim 1, wherein the integrated cap comprises a body.

9. The light fixture of claim 8, wherein the pole has a first shape cross-sectionally along a length of the pole, wherein a bottom end of the body of the integrated cap, when viewed from below, has the first shape.

10. The light fixture of claim 9, wherein the integrated cap further comprises an adapter coupled to a bottom end of the body, wherein the pole has an outer perimeter, wherein the bottom end of the body of the integrated cap has a first inner perimeter that is larger than the outer perimeter of the pole, wherein the adapter has a second inner perimeter and the first shape, wherein the second inner perimeter is substantially the same as the outer perimeter, wherein the adapter abuts against an outer surface of the pole.

11. The light fixture of claim 8, wherein the pole has a first shape cross-sectionally along a length of the pole, wherein a bottom end of the body of the integrated cap, when viewed from below, has a second shape.

12. The light fixture of claim 11, wherein the integrated cap further comprises an adapter coupled to a bottom end of the body, wherein the adapter abuts against an outer surface of the pole.

13. The light fixture of claim 12, wherein the pole has a first shape cross-sectionally along a length of the pole, wherein the adapter of the integrated cap, when viewed from below, has an inner surface that forms the first shape.

14. The light fixture of claim 8, wherein the integrated cap further comprises a stacking cap, wherein the stacking cap is disposed atop the body of the integrated cap, wherein the stacking cap comprises the at least one light fixture component coupling feature.

15. The light fixture of claim 14, wherein the stacking cap houses at least one additional light fixture component.

16. A bird deterrent accessory, comprising:
a base;
at least one coupling feature disposed in the base, wherein the at least one coupling feature is configured to couple to a component of a device; and
at least one bird deterrent feature that extends from the base, wherein the at least one bird deterrent feature is configured to deter birds from resting on or near the component of the device.

17. The bird deterrent accessory of claim 16, wherein the device is a pole-mounted light fixture.

18. An integrated cap for a pole-mounted light fixture, the integrated cap comprising:
a body comprising a plurality of walls that form a cavity; and
at least one light fixture component coupling feature disposed on at least one wall of the plurality of walls of the body, wherein the at least one light fixture component coupling feature is configured to couple to at least one light fixture component of the pole-mounted light fixture.

19. The integrated cap of claim 18, further comprising:
an adapter coupled to a bottom end of the body, wherein the adapter comprises an aperture that traverses therethrough, wherein the aperture is configured to have a shape and a size that is substantially similar to the shape and the size of an outer perimeter of a pole of the pole-mounted light fixture.

20. The integrated cap of claim 18, further comprising:
a stacking cap disposed atop the body, wherein the stacking cap is configured to enclose at least one additional light fixture component of the pole-mounted light fixture.
